(19) United States
(12) Patent Application Publication
(10) Pub. No.: US 2009/0038747 A1
(43) Pub. Date: Feb. 12, 2009

(54) Method for Continuously Producing a CCB Type "Electrode-Membrane-Electrode" Assembly

(75) Inventors: Herve Galiano, Joue les Tours (FR); Patrick Hourquebie, Esvres sur Indre (FR)

Correspondence Address: Nixon Peabody LLP, 200 Page Mill Road, Palo Alto, CA, 94306, US

(73) Assignee: COMMISSARIAT A L'ENERGIE ATOMIQUE, Paris (FR)

(21) Appl. No.: 12/084,359

(22) PCT Filed: Oct. 30, 2006
(86) PCT No.: PCT/EP2006/067928

§ 371 Date: Apr. 29, 2008

(30) Foreign Application Priority Data
Nov. 2, 2005 (EP) 05 53312

(51) Int. Cl. B32B 38/10; B32B 38/04

(52) U.S. Cl. 156/244.18; 156/247

(57) ABSTRACT

This invention relates to a method for continuously producing a CCB type of “Electrode-Membrane-Electrode” assembly comprising a polymer electrolyte membrane (26) on which a first electrode (21) formed from a first active layer and a first gas diffusion layer is formed on a first face, and a second electrode (21′) formed from a second active layer and a second gas diffusion layer is formed on a second face, in which the membrane and the two electrodes are assembled continuously by dynamic pressing at a temperature below 100° C., the outside surface of the active layer of each electrode, that will come into contact with a face of the membrane having firstly been heated to a temperature between 50° C. and 200° C., which comprises the following steps:
a step to position rolls for the polyelectrolyte membrane (26) and two peel-off adhesive backing films (23, 23′), and
a step to cut out electrodes (21, 21′) and deposit them on these backing films (23, 23′).

### TECHNICAL DOMAIN

The invention relates to a method for continuously producing a CCB type of “electrode-membrane-electrode” assembly.

### STATE OF PRIOR ART

The field of the invention is the field of “Electrode-Membrane-Electrode” (EME) assemblies of the CCB (Catalyst-Coated-Backing) type.

As shown in FIG. 1, such an EME assembly 10 comprises a polymer electrolyte membrane 11 on which a first electrode 12, for example of the anode type, formed from a first active layer 13 and a first gas diffusion layer 14 is formed on a first face, and a second electrode 15, for example of the cathode type, formed from a second active layer 16 and a second gas diffusion layer 17 is formed on a second face.

Such EME assemblies can be used in electrochemical systems operating by proton exchange and particularly in PEMFC (“Proton Exchange Membrane Fuel Cell”) type fuel cells.

Two technologies are used for continuous production of EME assemblies.

The first technology called CCM (“Catalyst-Coated-Membrane”), consists of continuously applying a catalyst layer on the two faces of an ionomer membrane by coating its two faces. One method using this first technology is described in documents reference [1] and [2] at the end of the description. This method gives a better catalyst/membrane contact, and producing conditions are not very restrictive. But this method cannot treat the two faces of the membrane simultaneously. Furthermore, the assembly of the diffusion layers remains a manual operation and is only envisaged during assembly of a fuel cell.

The second technology called CCB (“Catalyst-Coated-Backing”) consists of firstly coating a catalyst layer on the surface of each diffusion layer. The multi-layer assembly composed of an ionomer membrane located between two diffusion layers each coated with a catalyst layer is assembled when hot (temperature above 120° C.) and at a high pressure (pressure greater than 9 bars). The conditions for producing such an assembly cause a deformation and a physical degradation of the membrane, especially for thin membranes, and significant densification of the diffusion layers, which is prejudicial in the case of a fuel cell type application. One method using this second technology is described in document reference [3]. This method combines different co-extrusion, extrusion and/or lamination techniques. But this method cannot be used to make an EME assembly according to a predefined alternate scheme. Each diffusion layer coated with a catalyst layer is applied uninterruptedly to the membrane in a longitudinal direction, the diffusion layers conveying the EME assembly in this method. Furthermore, no information about the quality and performances of the EME assemblies thus obtained is presented.

The purpose of the invention is a method for producing a CCB type EME assembly starting from bulk electrodes and a membrane for overcoming the above disadvantages, this EME assembly being useable in an electrochemical system, for example such as a fuel cell.

### PRESENTATION OF THE INVENTION

The invention relates to a method for continuously producing a CCB type “Electrode-Membrane-Electrode” assembly comprising a polymer electrolyte membrane on which a first electrode formed from a first active layer and a first gas diffusion layer is deposited on a first face, and a second electrode formed from a second active layer and a second gas diffusion layer is deposited on a second face, in which the membrane and the two electrodes are assembled continuously by dynamic pressing at a temperature below 100° C., the outside surface of the active layer of each electrode that will come into contact with a face of the membrane having firstly been heated to a temperature between 50° C. and 200° C., characterised in that it comprises the following steps:
a step to position rolls for a polyelectrolyte membrane and two peel-off adhesive backing films, and
a step to cut out electrodes and deposit them on these backing films.

In one example embodiment, the active layer of each electrode is composed of a porous material containing carbon black or porous graphite covered by a finely divided noble metal and a thin deposit of an ionic conducting polymer. The active layer of each electrode thus comprises a catalyst and a polymer electrolyte.

The diffusion layer of each electrode comprises a porous material containing carbon black or porous graphite made hydrophobic by treatment.

In one advantageous embodiment, this method comprises the following steps:
an electrode heating step,
a step for assembling the electrodes on the membrane by cold rolling,
a step to separate and recover backing films on receiving reels,
a step to continuously recover the EME assembly on a reel, or to cut and package this assembly per unit.

Advantageously, this method can be done directly at the output from an extruder or a coating bench, to combine production of the membrane with production of the EME assembly.

Advantageously, this method for producing a CCB type EME assembly can be used for producing a fuel cell.

Advantageously, the method according to the invention is simpler, more efficient and better adapted to industrial constraints than methods according to known art.

The fact that the membrane is continuously assembled by cold dynamic pressing with electrodes previously heated to a temperature between 50° C. and 200° C. makes it possible to melt the surface of the active layers and to make intimate contact between the membrane and these electrodes, such contact being characterised by a lower production cost.

Advantageously the membrane that acts as support for the assembly of the two electrodes, conveys the assembly continuously.

The method according to the invention also has the following advantages:
The thermal stress on the membrane is negligible (the properties of the membrane are kept).
The thermal stress is only applied on a surface of each electrode.
No adhesive substances are used.
bulk electrodes are selectively deposited on each side of the membrane in x, y.

### BRIEF DESCRIPTION OF THE DRAWINGS

FIG. 1 shows an EME assembly according to known art.

FIG. 2 shows the method according to the invention.

FIG. 3 shows a method for cutting and depositing electrodes on a backing film, as is done in the method according to the invention.

FIG. 4 shows an embodiment of the method for continuously producing an EME assembly according to the invention.

FIG. 5 shows polarisation curves for two EME assemblies, one made using a standard method and the other using the method according to the invention.

### DETAILED PRESENTATION OF PARTICULAR EMBODIMENTS

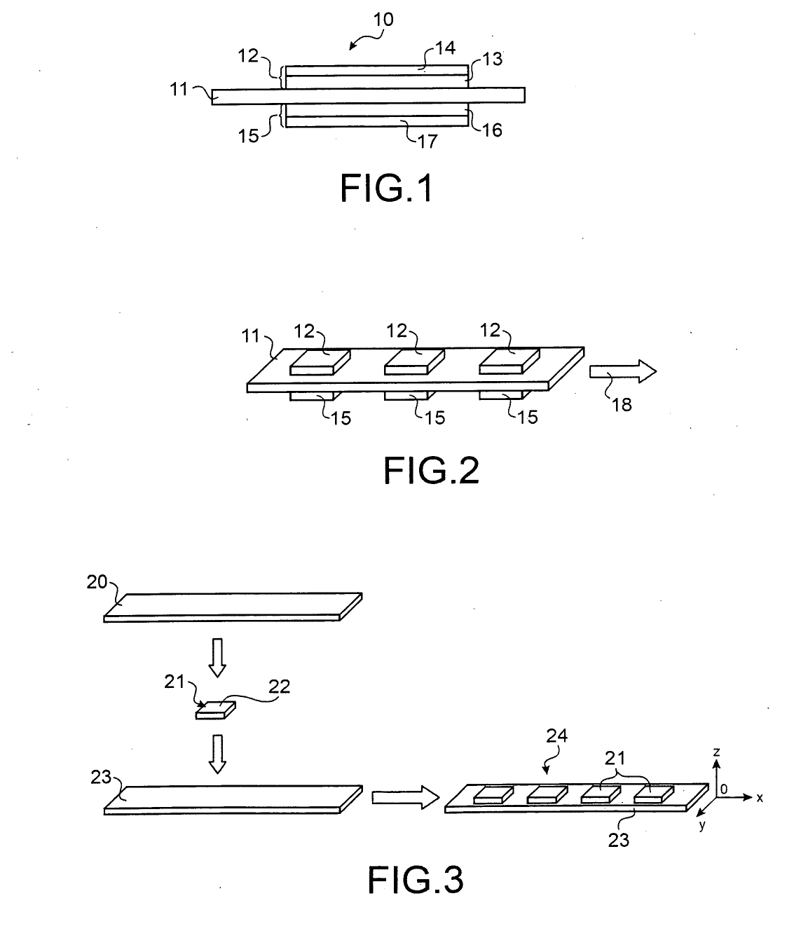

In a conventional method for producing an EME assembly of the CCB type as shown in FIG. 1, this assembly comprises a polymer electrolyte membrane on which a first electrode formed from a first active layer and a first gas diffusion layer is deposited on a first face, and a second electrode formed from a second active layer and a second gas diffusion layer is formed on a second face.

As shown in FIG. 2, the method according to the invention is a method in which this membrane 11 is assembled continuously (displacement 18) with electrodes 12 and 15 located on each side of it by dynamic pressing at a temperature below 100° C. In a preliminary step, the outside surface of the active layer of each electrode is heated to a temperature of between 50° C. and 200° C. before it comes into contact with a face of the membrane, which melts it to give good bond of each electrode in contact with the membrane.

The electrodes 12 and 15, thus used in the method according to the invention, are “bulk” electrodes that usually comprise an “active” layer and a “diffusion” layer.

The active layer may be composed of a catalyst, for example a porous material (felt, paper, fabric), for example “Teflon-coated”, in other words covered with PTFE, containing carbon black or porous graphite, covered by a finely divided noble metal, for example platinum grains, and a thin deposit of an ionic conducting polymer with a structure generally similar to the structure of the membrane.

The diffusion layer may be composed of a porous material, for example a Teflon-coated porous material containing carbon black or porous graphite made hydrophobic by treatment, for example by a PTFE deposit. The hydrophobic nature enables evacuation of liquid water during operation of the fuel cell.

In one embodiment of the method according to the invention, the first step is to cut out a tape 20 and to deposit bulk electrodes 21 thus cut out with their active zone 22 located on top, on two peel-off adhesive backing films 23 of the type shown in FIG. 3, such an operation typically being automated.

On the assembly 24 (24′) of electrodes (21) thus formed deposited on the surface of a film 23 (23′), the active layer of each electrode is then heated by a specific heating system 25 (25′) adapted to the active surface of each electrode, for example by electromagnetic, infrared radiation, etc. This temperature between 50° C. and 200° C. is such that it enables the active layer of each electrode to melt before assembly with the membrane.

The membrane and the two electrodes are assembled by a system bringing different films originating from two unwinding units for electrode backing films thus covered with electrodes and from a polyelectrolyte membrane roll 26, using a conventional “Roll-to-Roll” type method. Electrodes 21 and 21′ are then adjusted to face each other on each side of the membrane 26. The assembled laminate is then rolled in a two-cylinder rolling machine 27.

After rolling, the backing films of the two electrodes 23 and 23′ are separated and recovered on two receiving reels that maintain the tensions necessary for peel-off.

The continuous EME assembly 29 thus made may be recovered either directly on a motor driven receiving reel or it can be cut directly and packaged per unit, following the model shown in FIG. 1.

The method according to the invention thus comprises the following steps:
a step to position rolls for a polyelectrolyte membrane (26) and two peel-off adhesive backing films (23, 23′),
a step to cut out the electrodes (21, 21′) and deposit them on these backing films (23, 23′),
a step to heat the electrodes (25, 25′),
a step to assemble the electrodes on the membrane by cold rolling (27),
a step to separate and recover backing films (23, 23′) on the receiving reels,
a step to continuously recover the EME assembly (29) on a reel, or to cut and package this assembly (29) in units.

The method according to the invention that combines the “Roll-to-Roll”, electromagnetic heating of a specific surface and low temperature lamination technologies, maintains the integrity of the electrolyte membrane within the assembly, simplifies the installation and enables higher production rates.

The method according to the invention also enables direct integration at the output from an extruder or a coating bench, and a combination of production of the membrane with production of the EME assembly.

### EXAMPLE EMBODIMENT

This example embodiment of an EME assembly using the method according to the invention is designed to show in situ electrochemical properties (in other words in a test in a fuel cell) of an assembly made according to the invention, in comparison with a traditional assembly made manually.

1. Production According to a Traditional Method

In an example embodiment of a traditional EME assembly, the membrane and the electrodes are firstly cut to the required dimensions. Thus, a membrane with minimum dimensions 90 mm×90 mm may be cut out in a NAFION roll (registered trademark of the Dupont de Nemours Company) and two electrodes with minimum dimensions 53 mm×53 mm may be cut out in an electrode roll of the standard E-TEK type.

The membrane is placed manually between two facing electrodes. The assembly thus formed is then placed under a press at 0 bars for 3 minutes at 150° C., and then at 40 bars for 4 minutes at the same temperature, in order to obtain a good Electrode-Membrane-Electrode bond.

2. Embodiment Using the Method According to the Invention

The initial membrane is a NAFION type perfluorated membrane roll 117 (175 micron thick with an ionic exchange capacity of 1.1 meq/g), 400 mm wide and 10 linear meters long. The molecular structure of the NAFION is shown below.

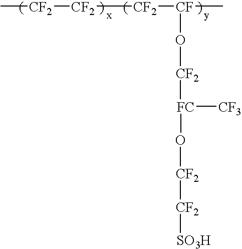

The initial electrodes originate from standard E-TEK electrode rolls and are composed of a carbon fabric platinum-coated on one face (supplier reference: Double Side Electrode 20% Pt on Vulcan XC-72, 0.35 mg/cm² Pt/C), 365 mm wide and 10 meters long.

As described above and as shown in FIG. 3, the electrode rolls are packaged, in other words are cut and positioned, on an adhesive transfer film. The surface of the electrodes is then heated in a controlled manner (in terms of exposure time and radiation power) to a temperature of about 150° C. by infrared electric heating with a power of 1500 watts.

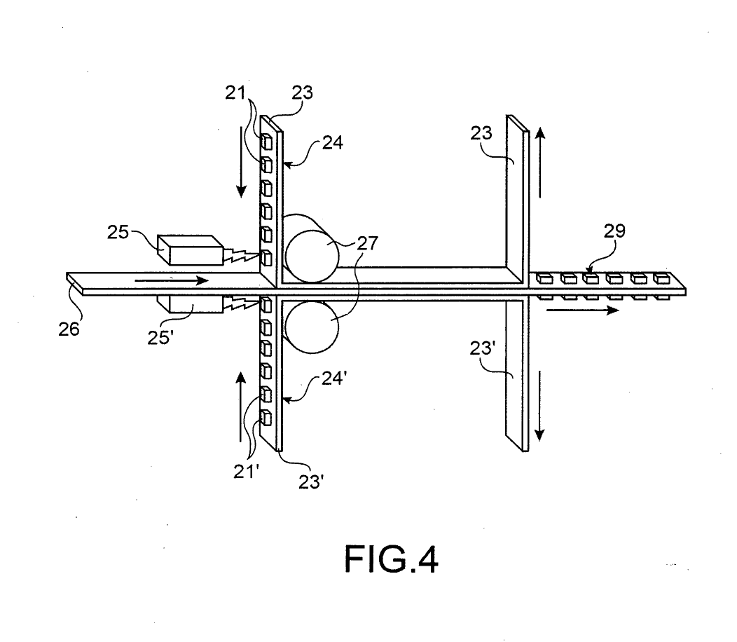

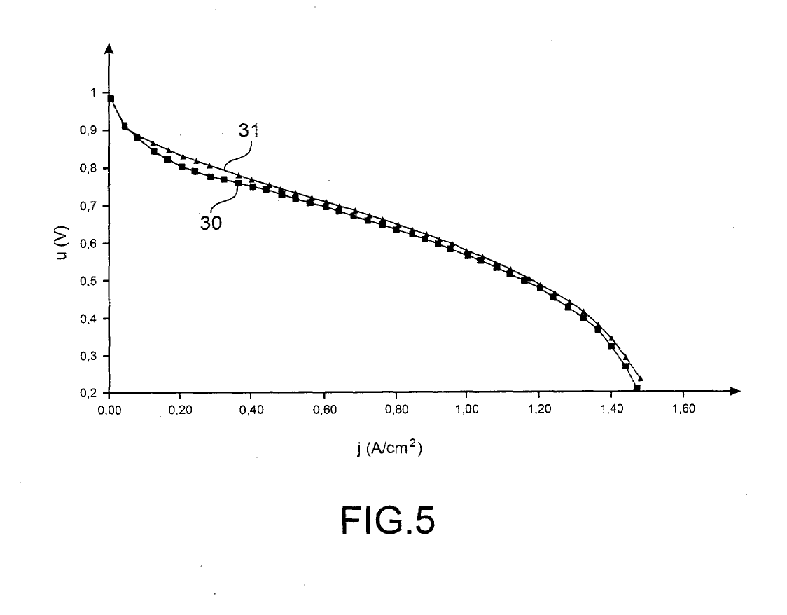

The assembly composed of the membrane and two electrode backing films is then rolled at ambient temperature at a rate of 1 m/min, as shown in FIG. 4.

3. In-situ Characterisation: Tests of Assemblies in Fuel Cells

Tests of the electrochemical performances of the EME assembly in fuel cells made using a single cell test bench, consist of testing this EME assembly between two graphite plates (single pole plates) to enable distribution of gases.

FIG. 5 shows the results of fuel cell tests carried out under optimum operating conditions for the NAFION membrane (80° C., at 1.5 bars, supply of H2/O2 gas).

A comparison of curves showing the bias voltage u (volts) as a function of the current density j (A/cm²) thus obtained with a standard assembly (curve 30) and the assembly according to the invention (curve 31) made using the same basic materials shows that the performance obtained with the continuous method according to the invention is comparable or even better.

### REFERENCES

[1] U.S. Pat. No. 6,500,217
[2] US 2002/034 674
[3] U.S. Pat. No. 6,291,091

1. Method for continuously producing a CCB type of “electrode-membrane-electrode” assembly comprising a polymer electrolyte membrane on which a first electrode formed from a first active layer and a first gas diffusion layer is formed on a first face, and a second electrode formed from a second active layer and a second gas diffusion layer is formed on a second face, in which the membrane and the two electrodes are assembled continuously by dynamic pressing at a temperature below 100° C., the outside surface of the active layer of each electrode, that will come into contact with a face of the membrane having firstly been heated to a temperature between 50° C. and 200° C., which comprises the following steps:
a step to position rolls for the polyelectrolyte membrane 2 and two peel-off adhesive backing films, and
a step to cut out electrodes and deposit them on these backing films,
a step for heating electrodes,
a step for assembling the electrodes on the membrane by cold rolling,
a step to separate and recover backing films on receiving reels.

2. Method according to claim 1, in which the active layer of each electrode is composed of a porous material containing carbon black or porous graphite covered by a finely divided noble metal and a thin deposit of an ionic conducting polymer.

3. Method according to claim 2, in which the active layer of each electrode comprises a catalyst and a polymer electrolyte.

4. Method according to claim 1, in which the diffusion layer of each electrode comprises a porous material containing carbon black or porous graphite made hydrophobic by treatment.

5. Method according to claim 1 comprising the following steps:
a step for heating electrodes,
a step for assembling the electrodes on the membrane by cold rolling,
a step to separate and recover backing films on receiving reels,
a step to continuously recover the EME assembly on a reel, or to cut and package this assembly per unit.

6. Method according to claim 1 which is done directly at the output from an extruder or a coating bench, to combine production of the membrane with production of the EME assembly.

7. Method for producing a CCB type EME assembly that can be used for producing a fuel cell.
